(19) United States
(12) Patent Application Publication
(10) Pub. No.: US 2007/0112601 A1
(43) Pub. Date: May 17, 2007

(54) System of calibrating physicians' practices of medicine

(76) Inventors: Anuthep Benja-Athon, New York, NY (US); Nontawan Benja-Athon, Port Washington, NY (US)

Correspondence Address: ANUTHEP BENJA-ATHON, 210 E 36TH ST., NEW YORK, NY, 10016, US

(21) Appl. No.: 11/649,873

(22) Filed: Jan. 5, 2007

Related U.S. Application Data
(63) Continuation-in-part of application No. 11/242,461, filed on Oct. 4, 2005.
(63) Continuation-in-part of application No. 11/344,485, filed on Feb. 1, 2006.
(63) Continuation-in-part of application No. 11/293,689, filed on Dec. 5, 2005.

(51) Int. Cl. G06Q 10/00

(52) U.S. Cl. 705/2

(57) ABSTRACT

A system of standardizing and measuring physicians' practices of medicine and services to patients wherein digital information on medicine, health and health-care, health and health-care data on patients generated by physicians and information on physicians and physicians' practices of medicine and services are compiled and manipulated to generate data adaptable to produce outcomes for measuring and influencing physicians' practices of medicine and services.

The present invention is a continuation-in-part of application Ser. No. 11/242,461 entitled A Perfect System for Compensations for Physicians filed Oct. 4, 2005, and a continuation-in-part of application Ser. No. 11/344,485 entitled Physicians-Patients-Health-Care-Buyers Accounting System filed Feb. 1, 2006, and a continuation-in-part of application Ser. No. 11/293,689 entitled A System of Conserving Health-care Buyers' Resources filed Dec. 5, 2005—all are pending.

### FIELD OF INVENTION

A system of standardizing physicians' methods in medicine and surgery.

### BACKGROUND OF THE INVENTION

Hundreds of thousands of American physicians and health-care providers have been practicing medicine and surgery as art and science. However, in billions of instances each year, hundreds of thousand physicians' and health-care providers' decisions in their practices of medicine and surgery are more art than science as, in countless of instances, medicine was seen as an inexact science if not art. Consequently, in modern time, there are still immense differences and variabilities of medical and surgical practices—decision makings, diagnoses and treatments and related among same or similar physicians' practices of medicine and surgery yielding diverse outcomes, medical errors and mistakes resulting in morbidity and mortality and escalating health-care costs to health-care consumers and buyers leading to lower standard of living and loss of lives.

There is no prior art which provides the system and method of the present invention described infra.

The present invention, true to the spirit governing the pending patent applications of the present patent applicants, causes the physicians' practices of medicine and surgery to be more or almost all science. Consequently, the present invention provides a system and a method wherein physicians' practices of medicine and services to be rendered to patients are standardized thus optimized. Consequently, there will be much less medical errors and mistakes resulting in much less morbidity and mortality and loss of lives.

Furthermore, the curbing of escalating health-care costs leading to improve and higher standard of living for people.

### SUMMARY OF THE INVENTION

The practices of medicine and surgery are diverse, different, inefficient and prone to errors as there was heretofore no system or process which quality and quantity controls of the medical and surgical practices of physicians.

The present invention is a system and a method of standardizing, calibrating and measuring physicians' practices of medicine, surgery and services to patients. Said system comprises digital information on medicine, health and health-care, health and health-care data on patients generated by physicians and information on physicians and physicians' practices of medicine and surgery which are compiled and manipulated by computer program means for compiling and manipulating said data and information to generate data, standards or references which are used as standards or references on which subsequent individual data on patients generated by physicians are referred to, match, calibrated, compared with or measured against. The outcomes of said system and processes influence physicians' practices of medicine and surgery and services to patients and health-care costs.

### DESCRIPTION OF THE PREFERRED EMBODIMENTS

The present invention is a system and a process of manipulating digital information on medicine, health and health-care, digital health and health-care data on patients generated by physicians, digital information on physicians and digital information on physicians' practices of medicine and surgery for generating outcome means for measuring physicians' practices of medicine and surgery and services to patients, outcome means for comparing physicians' practices of or methods in medicine and surgery and services to patients and outcome means for influencing physicians' practices of medicine and surgery and services for to patients and outcome means for influencing health-care costs.

Said digital information on medicine on medical, surgical, health and health-care information documented in medical and surgical and health and health-care textbooks, journals, publications and the like in about 80 medical and surgical specialties or fields.

Said digital health and health-care data on thousands to millions of patients generated by physicians and are stored and retrieved in and by computers and servers for manipulating said data and information in a network or networks of computers and servers according the earlier teaching in pending patent applications of the present patent applicants.

Said digital information on physicians comprise individual unique information on individual physicians such as, but not limited to, names, dates of birth, social security numbers, federal tax identification numbers or the like, unique identification numbers, addresses, unique identification numbers of physicians' electronic, wire or wireless device means for communicating data and information with said computers and servers in said network or networks of computers and servers. Such device means is such as, but not limited, to computers, laptops, mobile and smart phones.

The digital information on physicians' health and health-care practices of medicine and surgery and services comprise first digital data generated by physicians on medical, surgical, health and health-care information as practiced or set as standards of medical and surgical practices in about 80 medical and surgical and health and health-care practices, specialties or fields.

Furthermore, said digital data on physicians' health and health-care practices and services comprise second digital data comprising the derivatives of manipulations of physicians' generations and computers' or servers' storage and manipulations of said digital health and health-care data on thousands to millions of patients. In other words, said digital health and health-care data on thousands to millions of patients generated by physicians and are stored and retrieved in and by computers and servers are manipulated by the computer programs or applications to generate, accumulate, store, retrieve and use medical, surgical, health and health-care databases which are standards, references or norms for practices in about 80 medical and surgical and health and health-care practices, specialties or fields and which all subsequent and relevant or related physicians' practices of medicine, surgery and health-care are referred to, compared with or measured against to achieve the objectives and goals of the present invention.

Yet furthermore, said digital data on physicians' health and health-care practices and services comprise third digital data comprising the derivatives of manipulations of physicians' generations and computers' or servers' storage and manipulations of said first and said second digital data. In other words, said first and second digital data are manipulated by the computer program means for generating, accumulating, storing, retrieving and using medical, surgical, health and health-care databases which are or serve as standards, references or norms for medical and surgical practices in about 80 medical and surgical and health and health-care practices, specialties or fields and which all subsequent and relevant or related physicians' practices of medicine, surgery and health-care are referred to, compared with or measured against to achieve the objectives and goals of the present invention.

Furthermore, the present invention also provides computer program means for measuring, calibrating and comparing data and information generated and mentioned herein to achieve the objectives and goals of the present invention.

Said computer programs or applications comprise programs of said data and information such as, but not limited to, said digital information on physicians comprise individual unique information on individual physicians such as, but not limited to, names, dates of birth, social security numbers, federal tax identification numbers or the like, unique identification numbers, addresses, unique identification numbers of physicians' said device means for communicating data and information, said digital health and health-care data on thousands to millions of patients generated by physicians, said first and second data.

Therefore, in said generations and applications of said second data, one of the preferred embodiments of the present invention can be illustrated as individual relationships of categories such as, but not limited to, chief complaints, diagnoses, tests, medications, treatments and complications in said second data generated by physicians on patients and compiled, stored, retrieved and used by said computer or computers or server or servers and serve as standards, referenced or norms for said individual relationships. Thus, any subsequent generated individual data on patients by physicians are referred to, match or compared with, calibrated or measured against said data standards by computer program means for comparing or analyzing individual data with or measuring individual data against individual data standards in about 80 medical and surgical specialties or practices dealing with diseases and disorders.

First example, in a most simplistic illustration based on said system, processes and programs, thousands of general surgeons per unit time generated data on thousands of patients who had gall bladder inflammation would have caused said computer(s) or server(s) to generate and store according to said system and process a pooled data or a standard comprising related categories comprises:
chief complaint diagnosis tests
medications treatments complications
   or
right upper quadrant abdominal pain jaundice cholecystitis ultrasound
no medication cholecystectomy no complication

Three subsequent general surgeons, for example, may generate data on his three patients who had gall bladder inflammation and present their data to said computer means and computer program means as:
first patient:
right upper quadrant abdominal pain jaundice cholecystitis ultrasound
no medication cholecystectomy no complication
   and
second patient:
right upper quadrant abdominal pain jaundice peptic ulcer no test
morphine sulfate
   and
third patient:
right upper quadrant abdominal pain jaundice pneumonia chest x-ray
oral penicillin no treatment ruptured gall bladder and peritonitis

Second example, in a most simplistic illustration based on said system, processes and programs, thousands of neurologists per unit time generated data on patients who had headaches would have caused said computer(s) or server(s) to generate and store according to said system and process a pooled relationship or a standard comprising related categories:
chief complaint diagnosis tests
medications treatments complications
   or
headache fever meningismus meningitis lumbar puncture
intravenous penicillin no treatment no complication

Four subsequent neurologists, for example, may generate data on their four patients who had headache and present their data to said computer means and computer program means as:
first patient:
headache fever meningimus meningitis lumbar puncture
intravenous penicillin no treatment no complication
   and
second patient:
headache fever meningismus psychogenic headache no test
motrin no treatment
   and
third patient:
headache fever meningismus psychogenic headache no test
motrin no treatment seizure coma encephalopathy
   and
fourth patient:
headache fever meningismus cervicogenic headache electrodiagnosis
muscle relaxant no treatment death

Third example, yet another simplistic illustration based on said system, processes and programs, thousands of endocrinologist per unit time generated data on patients who had diabetes mellitus would have caused said computer(s) or server(s) to generate and store according to said system and process a pooled relationship or a standard comprising related categories:
patients chief complaint diagnosis
tests medications
treatments complications
   or
Young adults polyuria polydipsia diabetes mellitus type 1
fasting blood glucose levels subcutaneous insulin
no treatment no complication

Two subsequent endocrinologists, for example, may generate data on their two patients who had said symptoms and present their data to said computer means and computer program means as:
first patient:
polyuria polydipsia diabetes mellitus fasting blood glucose level
glypizide no treatment poorly controlled blood glucose
   and
second patient:
polyuria polydipsia diabetes mellitus type2 fasting blood glucose levels
subcutaneous insulins no treatment hypoglycemic crises

Said preferred embodiments are used and applied to the generations and developments of said relationship of categories on diseases and disorders in about 80 medical and surgical specialties or practices. Furthermore, said preferred embodiments can and will further comprise diverse and different relationships of said categories to achieve the objectives and goals of the present invention. Furthermore, more categories than said number of categories including consultations, frequencies, recurrences, revisions, frequencies of consultations, frequencies of recurrences, episodes, frequencies of revisions, hospital admissions, emergency room utilizations and frequencies of said utilizations can and will be used to achieve the objectives and goals of the present invention. Consequently, the present invention provides thousands of standards or references and related adaptations and variations for or applicable to diseases and disorders in about 80 medical and surgical specialties or practices.

It is understood that the present invention said computer program or programs include the ability to establish and apply only standards comprise correct or meaningful relationships of said data, information and categories through computer program or programs, human efforts and any thereof. Wrong or meaningless relationships are rejected and not used.

Although said preferred embodiments has been used for illustration of relationships of said categories, it will be appreciated by those skilled in art and medicine that variations and adaptations of said one preferred embodiment are to be made and achieved for physicians' practices, specialties or medicine or surgical fields to achieve the objectives and goals of the present invention.

According to said one of the preferred embodiments of the present invention, said computer or server means and computer program means compared or matched said data generated by said subsequent three general surgeons or four neurologists—or physicians of about 80 medical and surgical specialties or practices in appropriate settings and circumstances taught supra and by the pending applications of the present patent applicants—with said standards or pooled data continually generated by thousands of general surgeons or thousands of neurologists—or physicians of about 80 medical specialties or practices in appropriate settings and circumstances taught supra by the pending applications of the present patent applicants—and manipulated by said computer or server means and computer program means and accordingly manage the outcomes of said processes adaptable to be viewed and feedback to physicians and parties concerned to achieve the objectives and goals of the present invention.

It is further understood that said illustrations are schematic description of one of the preferred embodiments of the present invention, and, therefore, the generation and design of the computer program or programs and the applications of the present invention in the computers and servers are based on the objectives and goals of the present invention.

It is to be understood that the words “practices” and “services” used in the present application mean the physicians' methods, performances, acts, accomplishments or executions and the word “medicine” encompasses medicine, surgery and health-care or about 80 medical and surgical specialties, practices or fields.

Although the preferred embodiments have been described for human patients, it will be appreciated by those skilled in art and medicine that the present invention can be used and applied to animals without departing from the spirit of the invention and the scope of the claims.

Although the preferred embodiments have been described, it will be appreciated by those skilled in art and medicine that variations, additions and adaptations to the present invention can be made without departing from the spirit of the invention and the scope of the claims.

1. A system of manipulating digital information on medicine, health and health-care, digital health and health-care data on patients generated by physicians for generating outcome means for influencing physicians' practices of medicine and services to patients and health-care costs comprises:
information on medicine;
information on health and health-care;
digital health and health-care data on patients generated by physicians;
digital information on physicians;
digital data on physicians' health and health-care practices;
digital data on physicians' health and health-care services;
a process of manipulating said information and data;
an outcome means for influencing physicians' practices and services;
a process of manipulating said outcome means for influencing physicians' practices; and
a process of manipulating said outcome means for influencing physicians' services.

2. A system of measuring physicians' health-care practices of medicine and services provided to patients wherein digital information on medicine, health and health-care, digital health and health-care data on patients generated by physicians and digital information on physicians and physicians' health and health-care practices are manipulated to generate outcome means for measuring and influencing physicians' practices of medicine and services to patients and health-care costs comprises:
information on medicine;
information on health and health-care;
digital health and health-care data on patients generated by physicians;
digital information on physicians;
digital data on physicians' health and health-care practices;
digital data on physicians' health and health-care services;
a process of manipulating said information and data;
an outcome means for influencing physicians' practices and services;
a process of manipulating said outcome means for influencing physicians' practices; and
a process of manipulating said outcome means for influencing physicians' services.

3. A system of calibrating physicians' practices of medicine and services provided to patients wherein digital information on medicine, health and health-care, digital health and health-care data on patients generated by physicians and digital information on physicians and physicians' health and health-care practices are compiled to generate outcome means for measuring and influencing physicians' practices of medicine and services to patients comprises:
information on medicine;
information on health and health-care;
digital health and health-care data on patients generated by physicians;
digital information on physicians;
digital data on physicians' health and health-care practices;
digital data on physicians' health and health-care services;
a process of manipulating said information and data;
an outcome means for influencing physicians' practices and services;
a process of manipulating said outcome means for influencing physicians' practices; and
a process of manipulating said outcome means for influencing physicians' services.
